(19) United States
(12) Patent Application Publication
(10) Pub. No.: US 2014/0313803 A1
(43) Pub. Date: Oct. 23, 2014

(54) TRANSFORMERLESS DC/AC CONVERTER

(71) Applicant: FAIRCHILD KOREA SEMICONDUCTOR LTD., Bucheon (KR)

(72) Inventors: Jacobo Aguillon-Garcia, Bucheon (KR); Pedro Bañuelos-Sánchez, Cholula (MX)

(73) Assignee: Fairchild Korea Semiconductor Ltd., Bucheon (KR)

(21) Appl. No.: 13/864,574

(22) Filed: Apr. 17, 2013

(51) Int. Cl. H02M 7/5388

(52) U.S. Cl. CPC H02M 7/5388
USPC 363/132

(57) ABSTRACT

A method for generating an AC power signal using a transformerless DC/AC converter includes energizing a first inductor circuitry from a DC input source by controlling first, second and third switches to couple the first inductor circuitry to the DC input source; de-energizing the first inductor circuitry by controlling the first, second and third switches to decouple the first inductor circuitry from the DC input source and couple the first inductor circuitry to an output node to generate, at least in part, a first half cycle of an AC power signal at the output node; energizing a second inductor circuitry from a DC input source by controlling fourth, fifth and sixth switches to couple the second inductor circuitry to the DC input source; and de-energizing the second inductor circuitry by controlling the fourth, fifth and sixth switches to decouple the second inductor circuitry from the DC input source and couple the second inductor circuitry to the output node to generate, at least in part, a second half cycle of the AC power signal at the output node.

### FIELD

The present disclosure relates to DC to AC converter circuitry, and, more particularly, to a transformerless DC to AC converter topology.

### BACKGROUND

It is known that the energy extracted from some alternative power sources or conventional storage methods is accessible in a direct current (DC) manner. The energy consumed for industrial, as well as for household appliances, must be transformed from the primal source for a proper utilization of the energy. Typically, DC voltage from photovoltaic (PV), fuel cell, wind or sea wave generator source is converted to an AC voltage. This power conversion conventionally requires certain stages including, for example, energy storage, inversion, rectifier, filtering, etc. Rectification and filtering are well-known architectures, and are generally efficient. However, the core of the energy transformation requires the use of an inverter stage. The inverter stage generates an alternating voltage/current, with a desired frequency and/or energy density, from a continuous or discontinuous input power (i.e. pure DC voltage or with certain level variations), utilizing power transistors. There exists a great variety of inverter architectures, which are typically implemented with controlled switches for frequency transforming. However, most of the inverter topologies need a pre-process DC-link interphase to achieve the desired effect on DC to AC conversion. Therefore, with conventional approaches, it is not always possible to attain direct conversion form DC to AC due to technology constrains and the problems associated with inter-processing of the energy. Instead, the conventional approaches often have to rely on complex (and expensive) transformer-based topologies to achieve results.

### BRIEF DESCRIPTION OF DRAWINGS

Features and advantages of the claimed subject matter will be apparent from the following detailed description of embodiments consistent therewith, which description should be considered with reference to the accompanying drawings, wherein:

FIG. 1 illustrates a transformerless DC/AC converter system consistent with various embodiments of the present disclosure;

FIG. 2 illustrates control circuitry for the transformerless DC/AC converter of FIG. 1;

FIG. 3 illustrates signal plots of various control reference signals of the control circuitry of FIG. 2;

FIG. 4 illustrates operational signal plots of the control and output signals of the transformerless DC/AC converter system of FIG. 1; and

FIG. 5 is a flowchart of operations according to one embodiment of the present disclosure.

Although the following Detailed Description will proceed with reference being made to illustrative embodiments, many alternatives, modifications, and variations thereof will be apparent to those skilled in the art.

### DETAILED DESCRIPTION

Generally, this disclosure provides a transformerless DC/AC converter system that could be used as stand-alone circuit unit or final post-process stage. In addition, the transformerless DC/AC converter system provides a simple, low cost control approach in order to obtain a wide frequency and output voltage range. In some embodiments, the transformerless DC/AC converter system is configured to provide dynamic load side power support, active power reduction/injection depending on frequency, decoupling of source-load system in order to reduce CCM (Common Conduction Mode) noise, high-power density architecture, and/or low harmonic distortion content due to direct sinusoidal conversion.

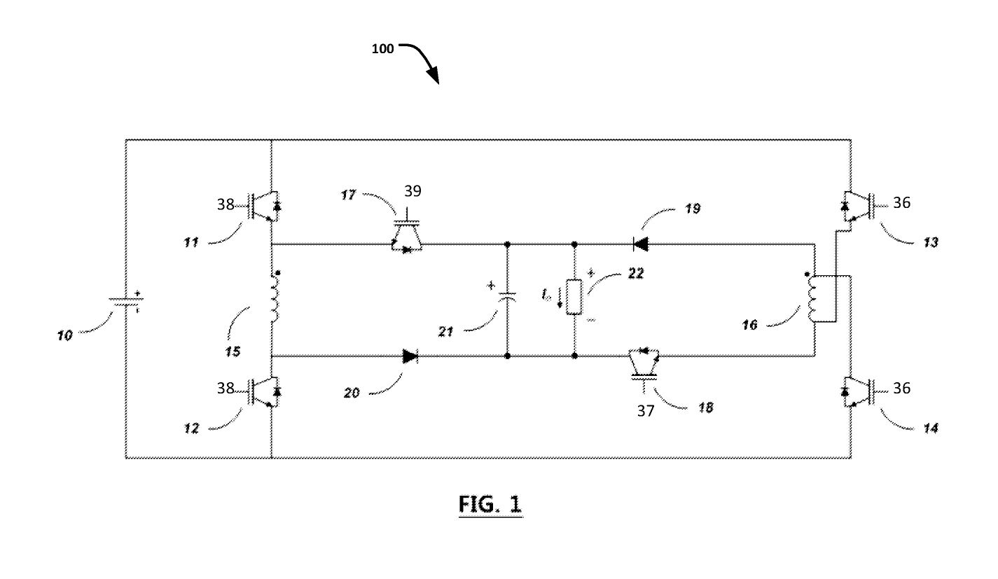

FIG. 1 illustrates a transformerless DC/AC converter system 100 consistent with various embodiments of the present disclosure. The DC/AC converter system 100 depicted in FIG. 1 may be included with, or form part of, a general-purpose or custom integrated circuit (IC) such as a semiconductor integrated circuit chip, system on chip (SoC), power module, etc. As a general overview, the DC/AC converter system 100 includes DC input power 10 and a plurality of switches 11, 12, 13, 14 operable to deliver sinusoidal (or quasi-sinusoidal) AC power to an output node 22. Switches 11 and 12 are coupled to first inductor circuitry 15 and to the DC input power 10. Switch 17 is coupled between the first inductor circuitry 15 and to output smoothing capacitor circuitry 21 and to the load 22. Switches 11 and 12, together, are configured to switch in a complimentary fashion with switch 17, i.e., when switches 11 and 12 are ON, switch 17 is OFF, and vise-versa. Switches 13 and 14 are coupled to second inductor circuitry 16 and to the DC input power 10. Switch 18 is coupled between the second inductor circuitry 16 and to output smoothing capacitor circuitry 21 and to the load 22. Switches 13 and 14, together, are configured to switch in a complimentary fashion with switch 18, i.e., when switches 13 and 14 are ON, switch 18 is OFF, and vise-versa. First inductor circuitry 15 is coupled in reverse polarity from the second inverter circuitry 16, to enable generation of both positive and negative half cycles of AC output power. Blocking diode circuitry 19 and 20 are configured to isolate switches 11, 12 and 17 from switches 13, 14 and 18 during operation. The switches 11, 12, 13, 14, 17 and 18 are each shown and described herein as a bipolar junction transistor (BJT), however, any or all of the switch devices shown and described herein may include any type of known or after-developed switch technology such as, for example, MOS transistor, SiC, GaN etc., and/or other well-known or after-developed switch configuration. The BJT switches may include body diode portions, as may be well known, that may be used as blocking diodes, in addition to diodes 19 and 20. As will be explained in greater detail below, switches 11, 12 and 17 are controlled to deliver a first half-cycle of the output AC power to the load 22, via first inductor circuitry 15, and switches 13, 14 and 18 are controlled to deliver a second half-cycle of the output AC power to the load 22, via second inductor circuitry 16.

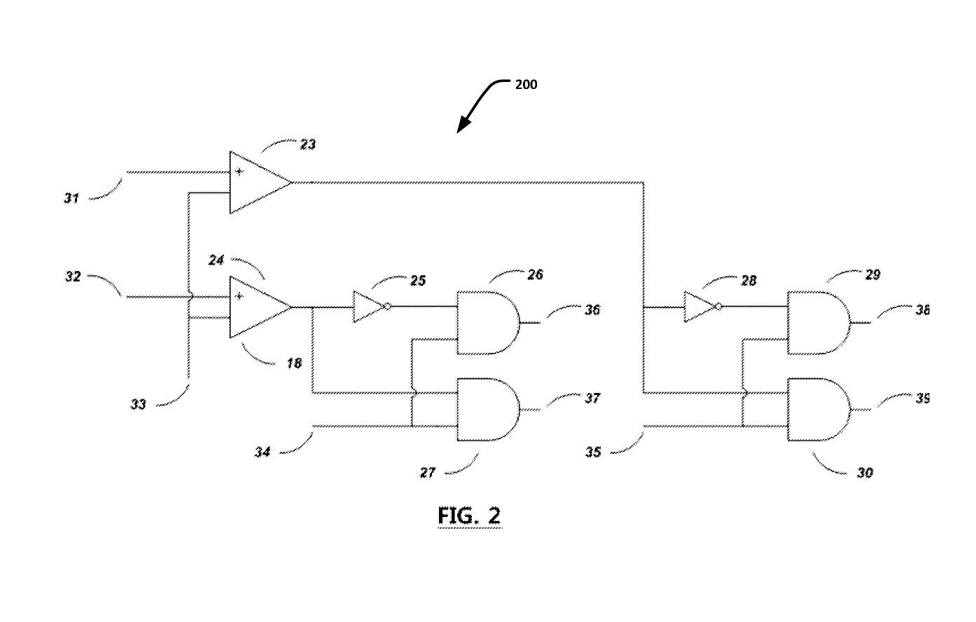

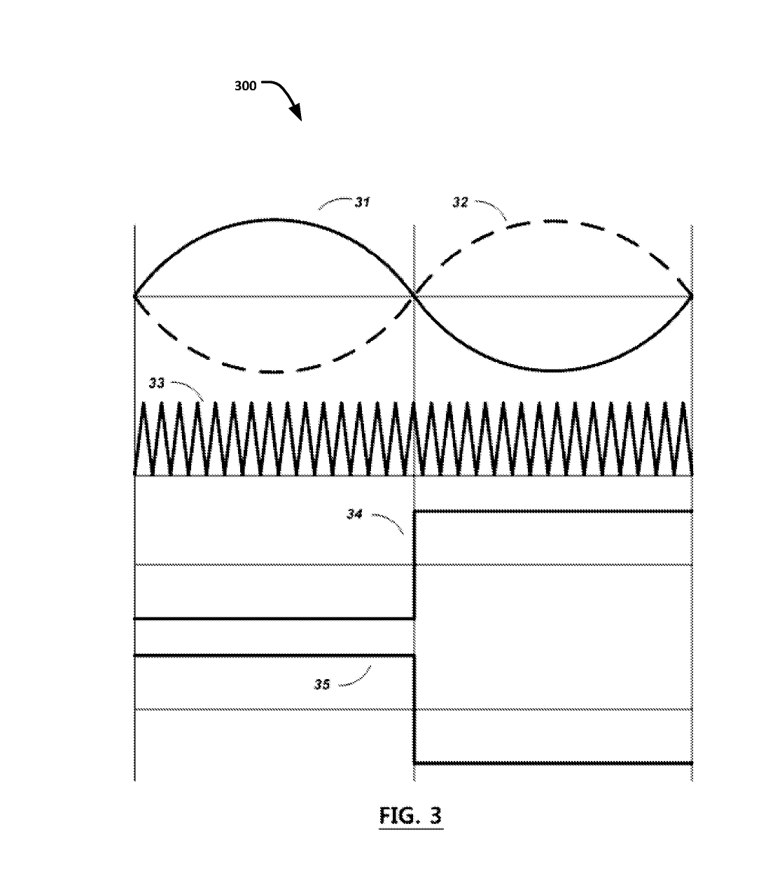

FIG. 2 illustrates control circuitry 200 for the transformerless DC/AC converter of FIG. 1. The control circuitry 200 is provided to control the conduction states of switches 11, 12, 13, 14, 17 and 18 to generate AC power to the load 22 from the DC input voltage 10. The control circuitry 200 includes comparator circuitry 23, inverter circuitry 28, and AND gates 29 and 30 to control the conduction states of switches 11, 12 and 17 to generate the first half cycle of the AC. The control circuitry 200 also includes comparator circuitry 24, inverter circuitry 25, and AND gates 26 and 27 to control the conduction states of switches 13, 14 and 18 to generate the second half cycle of AC power. FIG. 3 illustrates signal plots 300 of various reference signals of the control circuitry of FIG. 2. Signal 31 is a sinusoidal reference signal having a frequency f, where f is the frequency of the output AC power. Signal 32 is a complimentary sinusoidal reference signal having a frequency f, and approximately 180 degrees out-of-phase with signal 31. Thus, the frequency, f, of signals 31 and 32 may be used to control the frequency of the output AC power. Signal 33 is a sawtooth reference signal. The frequency of the sawtooth reference signal 33 may be several orders of magnitude greater than f (e.g., 40 kHz), and may generally be selected based on, for example, a desired granularity (smoothness) of the AC output power, circuit operating limits/tolerances, etc. Signals 34 and 35 are complimentary rectangular wave reference signals that are used to enable and disable portions of the control circuitry 200. Signals 34 and 35 each have a frequency of f. The y-axis (voltage amplitude) of the signal plots 200 is arbitrary, and may be based on, for example, circuit operating limits/ tolerances, etc.

Referring again to the control circuitry 200 of FIG. 2, comparator 23 is configured to compare the sinusoidal reference signal 31 with the sawtooth reference signal 33. If signal 31 is greater than signal 33, the output of the comparator 23 is high (e.g., a logic 1). If signal 31 is less than signal 33, the output of comparator 23 is low (e.g., a logic 0). The output of comparator 23 is used as an input to AND gate 30, to generate control signal 39. The output of comparator 23 is inverted (e.g., low to high, or high to low) by inverter circuitry 28 and the output of inverter circuitry 28 is used as an input to AND gate 29, to generate control signal 38. Enable signal 35 is used as an input to both AND gates 29 and 30, and thus, when the enable signal 35 is low, the output of AND gates 29 and 30 are low, regardless of any other signal input to the AND gates 29 and 30. When enable signal 35 is high, the signal state of control signal 38 (output of AND gate 29) will depend upon the signal state of the output of inverter circuitry 28 and the signal state of control signal 38 (output of AND gate 30) will depend upon the signal state of the output of the comparator circuitry 23. Control signal 38 and 39 are generally complimentary sinusoidal pulse width modulation (SPWM) signals that are used to control switches 11, 12 and 17 during a positive one half cycle of the sinusoidal reference signal 31.

Comparator 24 is configured to compare the sinusoidal reference signal 32 with the sawtooth reference signal 33. If signal 32 is greater than signal 33, the output of the comparator 24 is high (e.g., a logic 1). If signal 32 is less than signal 33, the output of comparator 24 is low (e.g., a logic 0). The output of comparator 24 is used as an input to AND gate 27, to generate control signal 37. The output of comparator 24 is inverted (e.g., low to high, or high to low) by inverter circuitry 25 and the output of inverter circuitry 25 is used as an input to AND gate 26, to generate control signal 36. Enable signal 34 is used as an input to both AND gates 26 and 27, and thus, when the enable signal 34 is low, the output of AND gates 26 and 27 are low, regardless of any other signal input to the AND gates 26 and 27. When enable signal 34 is high, the signal state of control signal 36 (output of AND gate 26) will depend upon the signal state of the output of inverter circuitry 25 and the signal state of control signal 37 (output of AND gate 27) will depend upon the signal state of the output of the comparator circuitry 24. Control signal 36 and 37 are generally complimentary sinusoidal pulse width modulation (SPWM) signals that are used to control switches 13, 14 and 18 during a positive one half cycle of the sinusoidal reference signal 32.

In operation, and referring again to FIG. 1 with continued reference to FIGS. 2 and 3, when enable signal 35 is high (and enable signal 34 is low), switches 11, 12 and 17 are enabled to generate a half cycle of the output AC power. When control signal 38 is high and control signal 39 is low, switches 11 and 12 are ON (i.e., conducting) and switch 17 is OFF (i.e., non-conducting). During this time, DC input source 10 energizes the first inductor circuitry 15. When control signal 38 is low and control signal 39 is high, switches 11 and 12 are OFF and switch 17 is ON. During this time, the first inductor circuitry 15 is de-energized to the capacitor 21 and to the load 22. This process is repeated while enable signal 35 is high to deliver a half cycle of AC power to the load 22. During this half cycle, switches 13, 14 and 18 are held OFF, thus isolating the second inductor circuitry 16 from the operations of the first inductor circuitry 15. When enable signal 34 is high (and enable signal 35 is low), switches 13, 14 and 18 are enabled to generate a second half cycle of the output AC power. When control signal 36 is high and control signal 37 is low, switches 13 and 14 are ON and switch 18 is OFF. During this time, DC input source 10 energizes the second inductor circuitry 16. When control signal 36 is low and control signal 37 is high, switches 13 and 14 are OFF and switch 18 is ON. During this time, the second inductor circuitry 16 is de-energized to the capacitor 21 and to the load 22. This process is repeated while enable signal 34 is high to deliver a second half cycle of AC power to the load 22. During this second half cycle, switches 11, 12 and 17 are held OFF, thus isolating the first inductor circuitry 15 from the operations of the second inductor circuitry 16.

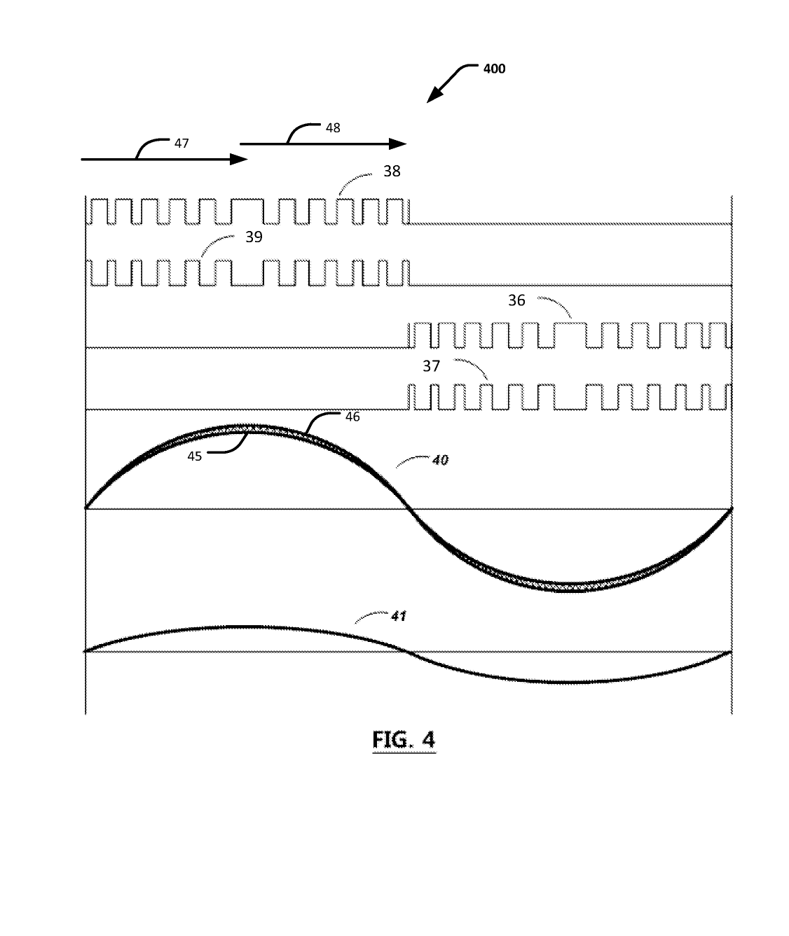

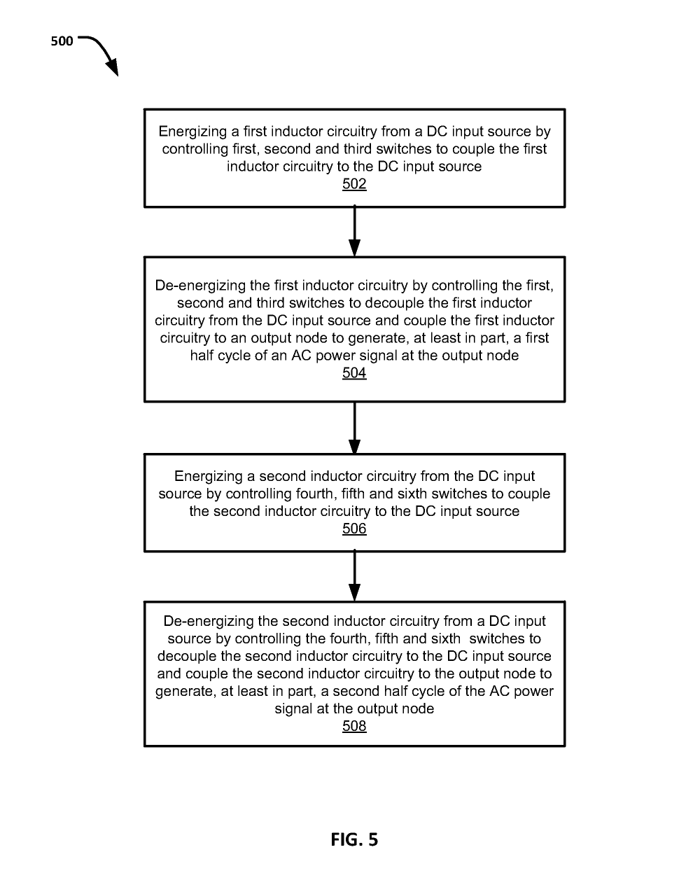

These concepts are depicted in FIG. 4. FIG. 4 illustrates operational signal plots 400 of the control and output signals of the transformerless DC/AC converter system of FIG. 1. Control signals 38 and 39 are generated during a first half cycle. Controls signals 38 and 39 are complimentary SPWM signals. The pulse width of signals 38 and 39 generally increase as the reference signal amplitude 31 increases (as designated by arrow 47) and generally decrease as the reference signal amplitude 31 decreases (as designated by arrow 48). Controls signals 36 and 37 are complimentary SPWM signals. The pulse width of signals 36 and 37 generally increase as the reference signal amplitude 32 increases and generally decrease as the reference signal amplitude 32 decreases. Output AC voltage 40 and current 41 are generated by energizing and de-energizing inductor circuitry 15 during the first half cycle and inductor circuitry 16 during the second half cycle, as described above. The output AC voltage 40 may include two separate waveforms 45 and 46. The signal 46 follows the signal 31 in the first half period which acts as modulating signal, and the signal 45 follows the signal 33 which acts as carrier signal. FIG. 5 is a flowchart of operations 500 according to one embodiment of the present disclosure. In particular, the flowchart 500 illustrates example operations for generating AC power using a transformerless DC/AC converter system. Operations of this embodiment include energizing a first inductor circuitry from a DC input source by controlling first, second and third switches to couple the first inductor circuitry to the DC input source 502. Operations of this embodiment also include de-energizing the first inductor circuitry by controlling the first, second and third switches to decouple the first inductor circuitry from the DC input source and couple the first inductor circuitry to an output node to generate, at least in part, a first half cycle of an AC power signal at the output node 504. Operations of this embodiment also include energizing a second inductor circuitry from a DC input source by controlling fourth, fifth and sixth switches to couple the second inductor circuitry to the DC input source 506. Operations of this embodiment also include de-energizing the second inductor circuitry by controlling the fourth, fifth and sixth switches to decouple the second inductor circuitry from the DC input source and couple the second inductor circuitry to the output node to generate, at least in part, a second half cycle of the AC power signal at the output node 508.

While the flowchart of FIG. 5 illustrates operations according to one embodiment, it is to be understood that not all of the operations depicted in FIG. 5 are necessary for other embodiments. In addition, it is fully contemplated herein that in other embodiments of the present disclosure, the operations depicted in FIG. 5, and/or other operations described herein may be combined in a manner not specifically shown in any of the drawings, and such embodiments may include less or more operations than are illustrated in FIG. 5. Thus, claims directed to features and/or operations that are not exactly shown in one drawing are deemed within the scope and content of the present disclosure.

The term, “circuitry” or “circuit”, as used in any embodiment herein, may comprise, for example, singly or in any combination, hardwired circuitry, programmable circuitry, state machine circuitry, and/or circuitry available in a larger system, for example, discrete elements that may be included as part of an integrated circuit. While the foregoing detailed description has provided a specific example with reference to controlling NPN-type BJT switches where the switch conducts when controlled by a high signal and turns off when controlled by a low signal, it is equally contemplated herein that the topology of FIG. 1 may use one or more p-type switches (active low) and the control circuitry of FIG. 2 may be modified accordingly to control the conduction state of one or more p-type switches in accordance with the teachings presented herein. Thus, the circuit topologies of FIGS. 1 and 2 are only examples of the general concept of providing a transformerless DC/AC converter according to the teachings presented herein. The output node 22 may be coupled to any type of load that would derive benefit of AC power, as understood by one skilled in the art, and thus the present disclosure is not intended to be limited to any specific type of load.

According, in one example embodiment the present disclosure provides A transformerless DC/AC converter system that includes first inductor circuitry configured to be selectively coupled to an input DC source; first and second switches coupled to the input DC source and to the first inductor circuitry and a third switch coupled to the first inductor circuitry and an output node; wherein conduction states of the first, second and third switches are configured to be controlled to energize the first inductor circuitry from the input DC source and de-energize the first inductor circuitry to generate a first half cycle of an AC power to the output node; second inductor circuitry configured to be selectively coupled to the input DC source; and fourth and fifth switches coupled to the input DC source and to the second inductor circuitry and a sixth switch coupled to the second inductor circuitry and the output node; wherein conduction states of the fourth, fifth and sixth switches are configured to be controlled to energize the second inductor circuitry from the input DC source and de-energize the second inductor circuitry to generate a second half cycle of the AC power to the output node.

In another example embodiment, the present disclosure provides a method for generating an AC power signal using a transformerless DC/AC converter. The method includes energizing a first inductor circuitry from a DC input source by controlling first, second and third switches to couple the first inductor circuitry to the DC input source; de-energizing the first inductor circuitry by controlling the first, second and third switches to decouple the first inductor circuitry from the DC input source and couple the first inductor circuitry to an output node to generate, at least in part, a first half cycle of the AC power signal at the output node; energizing a second inductor circuitry from a DC input source by controlling fourth, fifth and sixth switches to couple the second inductor circuitry to the DC input source; and de-energizing the second inductor circuitry by controlling the fourth, fifth and sixth switches to decouple the second inductor circuitry from the DC input source and couple the second inductor circuitry to the output node to generate, at least in part, a second half cycle of the AC power signal at the output node.

In another example embodiment, the present disclosure provides a transformerless DC/AC converter system that includes first inductor circuitry configured to be selectively coupled to an input DC source; first and second switches coupled to the input DC source and to the first inductor circuitry and a third switch coupled to the first inductor circuitry and an output node; wherein conduction states of the first, second and third switches are configured to be controlled to energize the first inductor circuitry from the input DC source and de-energize the first inductor circuitry to generate a first half cycle of an AC power to the output node; second inductor circuitry configured to be selectively coupled to the input DC source; and fourth and fifth switches coupled to the input DC source and to the second inductor circuitry and a sixth switch coupled to the second inductor circuitry and the output node; wherein conduction states of the fourth, fifth and sixth switches are configured to be controlled to energize the second inductor circuitry from the input DC source and de-energize the second inductor circuitry to generate a second half cycle of the AC power to the output node. The system of this embodiment also includes control circuitry configured to generate a first sinusoidal pulse width modulation (SPWM) control signal to control the conduction states of the first and second switches; a second SPWM control signal to control the conduction state of the third switch, wherein the first SPWM control signal is complementary to the second SPWM control signal; a third SPWM control signal to control the conduction states of the fourth and fifth switches; and a fourth SPWM control signal to control the conduction state of the sixth switch, wherein the third SPWM control signal is complementary to the fourth SPWM control signal.

The terms and expressions which have been employed herein are used as terms of description and not of limitation, and there is no intention, in the use of such terms and expressions, of excluding any equivalents of the features shown and described (or portions thereof), and it is recognized that various modifications are possible within the scope of the claims. Accordingly, the claims are intended to cover all such equivalents. Various features, aspects, and embodiments have been described herein. The features, aspects, and embodiments are susceptible to combination with one another as well as to variation and modification, as will be understood by those having skill in the art. The present disclosure should, therefore, be considered to encompass such combinations, variations, and modifications.

What is claimed is:

1. A transformerless DC/AC converter system, comprising:
first inductor circuitry configured to be selectively coupled to an input DC source;
first and second switches coupled to the input DC source and to the first inductor circuitry and a third switch coupled to the first inductor circuitry and an output node; wherein conduction states of the first, second and third switches are configured to be controlled to energize the first inductor circuitry from the input DC source and de-energize the first inductor circuitry to generate a first half cycle of an AC power to the output node;
second inductor circuitry configured to be selectively coupled to the input DC source; and
fourth and fifth switches coupled to the input DC source and to the second inductor circuitry and a sixth switch coupled to the second inductor circuitry and the output node; wherein conduction states of the fourth, fifth and sixth switches are configured to be controlled to energize the second inductor circuitry from the input DC source and de-energize the second inductor circuitry to generate a second half cycle of the AC power to the output node.

2. The transformerless DC/AC converter system of claim 1, wherein the conductions states of the first and second switches are configured to be controlled by a first sinusoidal pulse width modulation (SPWM) control signal, and the conduction state of the third switch is configured to be controlled by a second SPWM control signal, wherein the first SPWM control signal is complementary to the second SPWM control signal; and wherein the conduction states of the fourth and fifth switches are configured to be controlled by a third SPWM control signal, and the conduction state of the sixth switch is configured to be controlled by a fourth SPWM control signal, wherein the third SPWM control signal is complementary to the fourth SPWM control signal.

3. The transformerless DC/AC converter of claim 1, further comprising a first blocking diode coupled between the first inductor circuitry and the output node, and a second blocking diode coupled between the second inductor circuitry and the output node; wherein the second blocking diode is configured to isolate, at least in part, the second inductor circuitry from the first inductor circuitry during the generation of the first half cycle of the AC power; and wherein the first blocking diode is configured to isolate, at least in part, the first inductor circuitry from the second inductor circuitry during the generation of the second half cycle of the AC power.

4. The transformerless DC/AC converter system of claim 1, further comprising capacitor circuitry coupled to the third and sixth switches and the output node.

5. The transformerless DC/AC converter system of claim 1, further comprising control circuitry configured to generate:
a first sinusoidal pulse width modulation (SPWM) control signal to control the conduction states of the first and second switches;
a second SPWM control signal to control the conduction state of the third switch, wherein the first SPWM control signal is complementary to the second SPWM control signal;
a third SPWM control signal to control the conduction states of the fourth and fifth switches; and
a fourth SPWM control signal to control the conduction state of the sixth switch, wherein the third SPWM control signal is complementary to the fourth SPWM control signal.

6. The transformerless DC/AC converter system of claim 5, wherein the control circuitry is further configured to generate the first and second SPWM control signals based on, at least in part, a first sinusoidal reference signal, a sawtooth reference signal and a first enable signal; wherein the first sinusoidal reference signal and the first enable signal each has a frequency, f, and the sawtooth reference signal has a frequency greater than f; and wherein the control circuitry is further configured to generate the third and fourth SPWM control signals based on, at least in part, a second sinusoidal reference signal, the sawtooth reference signal and a second enable signal; wherein the second sinusoidal reference signal is complementary to the first sinusoidal reference signal, the second enable signal is complimentary to the first enable signal and the second sinusoidal reference signal and the second enable signal each has the frequency, f.

7. The transformerless DC/AC converter system of claim 6, wherein a frequency of the AC power is based on, at least in part, f.

8. The transformerless DC/AC converter system of claim 6, wherein the control circuitry comprises:
first comparator circuitry configured to compare the first sinusoidal reference signal with the sawtooth reference signal and generate a first output signal;
first inverter circuitry configured to receive the first output signal and generate a second inverted output signal;
first AND gate circuitry configured to AND the first enable signal and the second inverted output signal and generate the first SPWM control signal; and
second AND gate circuitry configured to AND the first enable signal and the first output signal and generate the second SPWM control signal.

9. The transformerless DC/AC converter system of claim 8, wherein the control circuitry further comprises:
second comparator circuitry configured to compare the second sinusoidal reference signal with the sawtooth reference signal and generate a third output signal;
second inverter circuitry configured to receive the third output signal and generate a fourth inverted output signal;
third AND gate circuitry configured to AND the second enable signal and the fourth inverted output signal and generate the third SPWM control signal; and
fourth AND gate circuitry configured to AND the second enable signal and the third output signal and generate the fourth SPWM control signal.

10. A method for generating an AC power signal using a transformerless DC/AC converter, comprising:
energizing a first inductor circuitry from a DC input source by controlling first, second and third switches to couple the first inductor circuitry to the DC input source;
de-energizing the first inductor circuitry by controlling the first, second and third switches to decouple the first inductor circuitry from the DC input source and couple the first inductor circuitry to an output node to generate, at least in part, a first half cycle of the AC power signal at the output node;
energizing a second inductor circuitry from a DC input source by controlling fourth, fifth and sixth switches to couple the second inductor circuitry to the DC input source; and
de-energizing the second inductor circuitry by controlling the fourth, fifth and sixth switches to decouple the second inductor circuitry from the DC input source and couple the second inductor circuitry to the output node to generate, at least in part, a second half cycle of the AC power signal at the output node.

11. The method of claim 10, further comprising:
isolating, at least in part, the second inductor circuitry from the first inductor circuitry during the generation of the first half cycle of the AC power signal; and
isolating, at least in part, the first inductor circuitry from the second inductor circuitry during the generation of the second half cycle of the AC power signal.

12. The method of claim 10, further comprising smoothing the AC power signal at the output node.

13. The method of claim 10, further comprising:
generating first sinusoidal pulse width modulation (SPWM) control signal to control the conduction states of the first and second switches;
generating a second SPWM control signal to control the conduction state of the third switch, wherein the first SPWM control signal is complementary to the second SPWM control signal;
generating a third SPWM control signal to control the conduction states of the fourth and fifth switches; and
generating a fourth SPWM control signal to control the conduction state of the sixth switch, wherein the third SPWM control signal is complementary to the fourth SPWM control signal.

14. The method of claim 13, further comprising:
generating the first and second SPWM control signals based on, at least in part, a first sinusoidal reference signal, a sawtooth reference signal and a first enable signal; wherein the first sinusoidal reference signal and the first enable signal each has a frequency, f, and the sawtooth reference signal has a frequency greater than f; and
generating the third and fourth SPWM control signals based on, at least in part, a second sinusoidal reference signal, the sawtooth reference signal and a second enable signal; wherein the second sinusoidal reference signal is complementary to the first sinusoidal reference signal, the second enable signal is complimentary to the first enable signal and the second sinusoidal reference signal and the second enable signal each has the frequency, f.

15. The method of claim 14, wherein a frequency of the AC power signal is based on, at least in part, f.

16. The method of claim 14, further comprising:
comparing the first sinusoidal reference signal with the sawtooth reference signal and generating a first output signal;
inverting the first output signal and generating a second inverted output signal;
ANDing the first enable signal and the second inverted output signal and generating the first SPWM control signal; and
ANDing the first enable signal and the first output signal and generating the second SPWM control signal.

17. The method of claim 16, further comprising:
comparing the second sinusoidal reference signal with the sawtooth reference signal and generating a third output signal;
inverting the third output signal and generating a fourth inverted output signal;
ANDing the second enable signal and the fourth inverted output signal and generating the third SPWM control signal; and
ANDing the second enable signal and the third output signal and generating the fourth SPWM control signal.

18. A transformerless DC/AC converter system, comprising:
first inductor circuitry configured to be selectively coupled to an input DC source;
first and second switches coupled to the input DC source and to the first inductor circuitry and a third switch coupled to the first inductor circuitry and an output node; wherein conduction states of the first, second and third switches are configured to be controlled to energize the first inductor circuitry from the input DC source and de-energize the first inductor circuitry to generate a first half cycle of an AC power to the output node;
second inductor circuitry configured to be selectively coupled to the input DC source;
fourth and fifth switches coupled to the input DC source and to the second inductor circuitry and a sixth switch coupled to the second inductor circuitry and the output node; wherein conduction states of the fourth, fifth and sixth switches are configured to be controlled to energize the second inductor circuitry from the input DC source and de-energize the second inductor circuitry to generate a second half cycle of the AC power to the output node; and
control circuitry configured to generate:
a first sinusoidal pulse width modulation (SPWM) control signal to control the conduction states of the first and second switches;
a second SPWM control signal to control the conduction state of the third switch, wherein the first SPWM control signal is complementary to the second SPWM control signal;
a third SPWM control signal to control the conduction states of the fourth and fifth switches; and
a fourth SPWM control signal to control the conduction state of the sixth switch, wherein the third SPWM control signal is complementary to the fourth SPWM control signal.

19. The transformerless DC/AC converter system of claim 18, wherein the control circuitry is further configured to generate the first and second SPWM control signals based on, at least in part, a first sinusoidal reference signal, a sawtooth reference signal and a first enable signal; wherein the first sinusoidal reference signal and the first enable signal each has a frequency, f, and the sawtooth reference signal has a frequency greater than f; and wherein the control circuitry is further configured to generate the third and fourth SPWM control signals based on, at least in part, a second sinusoidal reference signal, the sawtooth reference signal and a second enable signal; wherein the second sinusoidal reference signal is complementary to the first sinusoidal reference signal, the second enable signal is complimentary to the first enable signal and the second sinusoidal reference signal and the second enable signal each has the frequency, f; and wherein a frequency of the AC power is based on, at least in part, f.

20. The transformerless DC/AC converter system of claim 19, wherein the control circuitry comprises:
first comparator circuitry configured to compare the first sinusoidal reference signal with the sawtooth reference signal and generate a first output signal;
first inverter circuitry configured to receive the first output signal and generate a second inverted output signal;
first AND gate circuitry configured to AND the first enable signal and the second inverted output signal and generate the first SPWM control signal;
second AND gate circuitry configured to AND the first enable signal and the first output signal and generate the second SPWM control signal;
second comparator circuitry configured to compare the second sinusoidal reference signal with the sawtooth reference signal and generate a third output signal;
second inverter circuitry configured to receive the third output signal and generate a fourth inverted output signal;
third AND gate circuitry configured to AND the second enable signal and the fourth inverted output signal and generate the third SPWM control signal; and
fourth AND gate circuitry configured to AND the second enable signal and the third output signal and generate the fourth SPWM control signal.
